(19) United States
(12) Patent Application Publication
(10) Pub. No.: US 2008/0034026 A1
(43) Pub. Date: Feb. 7, 2008

(54) Method for improving computation precision in fast Fourier transform

(76) Inventors: Linfeng Guo, Cliffside Park, NJ (US); Yang Li, South Plainfield, NJ (US); Mark Sydorenko, New York, NY (US); Jun Tian, Edison, NJ (US); Hua Zheng, Secaucus, NJ (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/498,317

(22) Filed: Aug. 1, 2006

(51) Int. Cl. G06F 17/14; G06F 17/10; G06F 17/40

(52) U.S. Cl. 708/409; 702/189; 708/208; 708/403

(57) ABSTRACT

A method for improving precision in FFT calculations. For each iteration in an FFT implementation, a constant normalization multiplier is inserted such that the dynamic ranges of the input and output are the same. The final FFT output is multiplied by a constant normalization factor given by the number of iterations and the constant normalization multiplier.

### CROSS REFERENCE TO RELATED APPLICATIONS

n/a

### STATEMENT REGARDING FEDERALLY SPONSORED RESEARCH OR DEVELOPMENT

n/a

### BACKGROUND OF THE INVENTION

As is known, the discrete Fourier transform (DFT) is typically given as

$$X ( k ) = {\sum }_{n = 0}^{N - 1} x ( n ) {W}_{N}^{nk}$$

where

k=0,1, . . . , N−1,

$${W}_{N}^{nk} = {e}^{- j \frac{2 π nk}{N}} [ TWIDDLE FACTOR ] , and$$

N=number of samples.

A twiddle factor, in fast Fourier transform (FFT) algorithms, refers to the trigonometric constant coefficients that are multiplied by the data in the course of the algorithm. FFT divides a length-N DFT into two length-N/2 DFTs, each length-n/2 DFT into two length-N/4 DFTs, etc. Thus, FFT can be implemented in log₂N iterations. In prior approaches, the dynamic range of the input and the output for each iteration in an FFT implementation differs by a factor of two. To maximize computation precision, a change of dynamic range necessitates a change in the FFT twiddle factor normalization. Such a change in the twiddle factor is both time consuming and memory intensive.

### BRIEF SUMMARY OF THE INVENTION

Disclosed is a method for improving precision in FFT calculations. For each iteration in an FFT implementation, a constant normalization multiplier is inserted such that the dynamic ranges of the input and output are the same. The final output, i.e. the FFT output, is multiplied by a constant normalization factor given by the number of iterations and the constant normalization multiplier.

### BRIEF DESCRIPTION OF THE SEVERAL VIEWS OF THE DRAWINGS

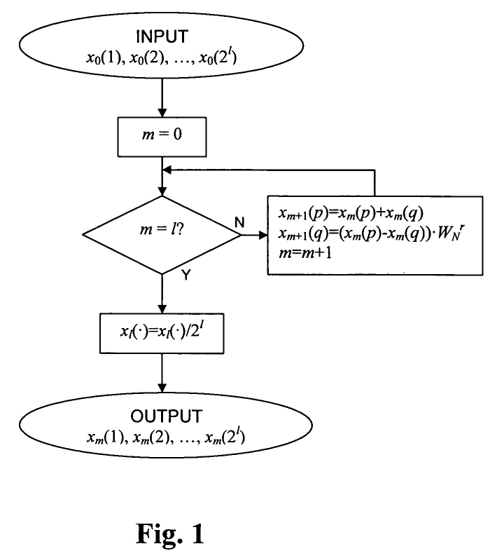

The invention will be more fully understood by reference to the following detailed description of the invention in conjunction with FIG. 1, which illustrates a method for improving computation precision in fast Fourier transformations, according to the presently disclosed invention.

### DETAILED DESCRIPTION OF THE INVENTION

In N-bit fixed-point computing, every integer value is in the range of [−2^{N-1}, 2^{N-1}]. If a value exceeds 2^{N-1}−1, an overflow occurs; if a value is below −2^{N-1}, an underflow occurs. Both overflow and underflow could be handled by requiring that the input data be sufficiently small so that the possibility of overflow/underflow is avoided. However, if the input data is small, computation precision can be sacrificed. Thus, balancing the tradeoff between overflow/underflow prevention and computation precision is an important goal in fixed-point computing. If not properly addressed, computation precision will be inferior.

As each number is represented by a finite-length sequence of binary digits, rounding (or truncation) brings in a computation error which can often be treated in terms of an additive noise. Such error is referred as a rounding error.

As shown above, the inverse discrete Fourier transform is

$$x ( n ) = \frac{1}{N} {\sum }_{k = 0}^{N - 1} X ( k ) {W}_{N}^{- kn} ,$$

where

n=0,1, . . . , N−1.

It is well known to those skilled in signal processing that the discrete Fourier transform and its inverse transform can be efficiently implemented by fast Fourier transform algorithms. The presently disclosed technique is illustrated in the context of an inverse discrete Fourier transform, though the forward discrete Fourier transform is processed in an analogous fashion.

For the inverse discrete Fourier transform, when N=2^{l} for some integer l, a decimation-in-frequency fast Fourier transform algorithm is commonly employed. The decimation-in-frequency fast Fourier transform algorithm is an iteration of a butterfly operation

$${x}_{m + 1} ( p ) = \frac{{x}_{m} ( p ) + {x}_{m} ( q )}{2} , \\ {x}_{m + 1} ( q ) = \frac{( {x}_{m} ( p ) - {x}_{m} ( q ) ) {W}_{N}^{r}}{2} .$$

where r is an exponential power, whose value depends on the locations of p and q.

In a fixed-point implementation, the dynamic range of {xₘ₊₁(p),xₘ₊₁(q)} is half of {xₘ(p),xₘ(q)}, which is undesirable for an implementation of iterative computation, as it would require different scaling factors for {xₘ(p),xₘ(q)} and for Fourier transform twiddle factors at each iteration. To keep the dynamic range of the input and output unchanged at each iteration, the following butterfly operation is applied instead

xₘ₊₁(p)=xₘ(p)+xₘ(q),

xₘ₊₁(q)=(xₘ(p)−xₘ(q))W_{N}^{r}.

### After the l-th iteration, the output results are scaled down by a factor of N=2^{l}, which normalizes the inverse Fourier transform coefficients back to their original ranges, with the precision of value of inverse Fourier transform coefficients improved.

The foregoing method for improving the computation precision in fast Fourier transform calculations can be implemented by a wide variety of computing hardware and software, including specially programmed general purpose computing systems, custom-designed computing hardware including application specific integrated circuits (ASICs), etc.

These and other embodiments of the invention illustrated above are intended by way of example and should not be viewed as limiting the scope of the disclosure or of the claims. The actual scope of the invention is to be limited solely by the scope and spirit of the following claims.

What is claimed is:

1. A method for improving the precision of fast Fourier transforms, comprising:
providing input samples {x₀(1), x₀(2), x₀(3), . . . x₀(k*2^{l})}, where k=0,1,2, . . . N−1;
for each iteration of m from 1 to l, performing a modified butterfly operation on the input samples, the modified butterfly operation taking the form
xₘ₊₁(p)=xₘ(p)+xₘ(q),
xₘ₊₁(q)=(xₘ(p)−xₘ(q))W_{N}^{r}.
where W_{N}^{r} is a twiddle factor and r is an exponential power dependant upon the locations of p and q; and
after the l-th iteration, scaling the output samples xₗ(p) and xₗ(q) by a factor of N=2^{l}.
